(19) United States
(12) Patent Application Publication
(10) Pub. No.: US 2002/0120487 A1
(43) Pub. Date: Aug. 29, 2002

(54) Referral systems for providing customers with information

(76) Inventor: Donald J. Fridrich, Nampa, ID (US)

Correspondence Address: HEWLETT-PACKARD COMPANY, Intellectual Property Administration, P.O. Box 272400, Fort Collins, CO, 80527-2400, US

(21) Appl. No.: 09/792,858

(22) Filed: Feb. 23, 2001

(51) Int. Cl. G06F 17/60

(52) U.S. Cl. 705/9

(57) ABSTRACT

Computer-based referral systems and methods are provided for enabling identification of persons possessing particular expertise and/or information over a network. A preferred method for providing such information to a customer includes the steps of: enabling receipt of personnel information corresponding to a first representative; enabling the first representative to be identified in response to a customer inquiry regarding a first subject matter; enabling communication with the first representative; and enabling the customer to be provided with information pertaining to the first subject matter. Computer readable media also are provided.

### BACKGROUND OF THE INVENTION

1. Field of the Invention

The present invention generally relates to communications networks and, more specifically, to systems and methods that are configured to, among other things, enable identification of persons possessing particular expertise. In some embodiments, although the invention is not limited to these configurations, the facilitates notifying, such as by page, the identified representative so that their particular expertise may be utilized for answering a question posed by a customer, for example.

2. Description of the Related Art

Many businesses cater to customers who are located in various geographical regions, e.g., worldwide. Thus, oftentimes, it is desirable for a business to provide twenty four hour customer assistance so as to be available to these customers whenever needed. Such assistance typically is provided by a customer service staff.

A typical customer service staff includes representatives who are responsible for receiving customer inquiries. These representatives may be able to provide customers with general information pertaining to frequently asked questions and/or products/services. When a customer requires information pertaining to a discrete area of expertise, however, such as technical knowledge regarding a particular product(s), for example, these representatives oftentimes may refer the customer to another representative who possesses the requisite expertise. By way of example, the customer may be referred to a staff engineer, e.g., an engineer associated with the product about which the customer is inquiring.

As is known, it may be exceedingly difficult to place a particular staff member in communication with a customer for the purpose of answering a question, or to obtain information from a staff member so that the information may be provided to the customer. Difficulties such as these may be exacerbated by factors such as a vast geographical staff distribution and a large number of products and/or services being offered, among others.

Therefore, there is a need for improved systems and methods that address these and other shortcomings of the prior art.

### SUMMARY OF THE INVENTION

Briefly described, the present invention relates to communications networks and, more specifically, to providing a customer with information via a communications network. In this regard, embodiments of the invention may be construed as providing methods for providing information to a customer. A preferred such method includes the steps of: enabling receipt of personnel information corresponding to a first representative; enabling the first representative to be identified in response to a customer inquiry regarding a first subject matter; enabling communication with the first representative; and enabling the customer to be provided with information pertaining to the first subject matter.

Other embodiments of the present invention may be construed as providing a referral system that is adapted to provide a customer with information. In a preferred embodiment, the referral system includes a standby system that is configured to receive personnel information corresponding to a first representative. The personnel information includes support category information and contact information. More specifically, the support category information pertains to subject matter about which the first representative potentially possesses knowledge, and the contact information pertains to at least one method of communicating with the first representative. The standby system is configured to store the personnel information and enables identification of the first representative, such as in response to a customer inquiry regarding subject matter associated with the first representative. Additionally, the standby system preferably enables communication with the first representative, such as by utilizing the contact information.

In some embodiments, the standby system is implemented via a Web site. In these embodiments, the Web site may provide an actuator corresponding to the first representative so that, in response to actuating the actuator, the Web site facilitates communication with the first representative by sending an email page, for example.

Other embodiments of the present invention may be construed as providing computer readable media. In this regard, a preferred embodiment includes logic configured to enable receipt of personnel information corresponding to a first representative, logic configured to enable the first representative to be identified in response to a customer inquiry regarding the first subject matter, and logic configured to enable communication with the first representative by utilizing the contact information.

Other features and advantages of the present invention will become apparent to one with skill in the art upon examination of the following drawings and detailed description. It is intended that all such features and advantages be included herein within the scope of the present invention, as defined in the appended claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting an embodiment of the referral system of the present invention.

FIG. 2 is a schematic diagram depicting a representative computer or processor-based system that may facilitate functionality of a standby system, which may be utilized by the referral system of FIG. 1.

FIG. 3 is a flowchart depicting functionality of a preferred embodiment of the standby system, such as the standby system depicted in FIGS. 1 and 2.

FIG. 4 is a flowchart depicting functionality of another embodiment of the present invention.

FIG. 5 depicts a representative page or window of a web site which may be implemented by a preferred embodiment of the standby system of the present invention.

FIG. 6 depicts a representative page or window of a web site which may be linked to the page depicted in FIG. 5.

FIG. 7 depicts a representative page or window of a web site which may be linked to the page depicted in FIG. 6.

FIG. 8 depicts a representative page or window of a web site which may be linked to the page depicted in FIG. 7.

FIG. 9 depicts a representative page or window of a web site which may be linked to the page depicted in FIG. 6.

FIG. 10 depicts a representative page or window of a web site which may be linked to the page depicted in FIG. 6.

FIG. 11 depicts a representative page or window of a web site which may be linked to the page depicted in FIG. 5.

FIG. 12 depicts a representative page or window of a web site which may be linked to the page depicted in FIG. 11.

FIG. 13 depicts a representative page or window of a web site which may be linked to the page depicted in FIG. 11.

FIG. 14 depicts a representative page or window of a web site which may be linked to the page depicted in FIG. 11.

FIG. 15 depicts a representative page or window of a web site which may be linked to the page depicted in FIG. 5.

FIG. 16 depicts a representative page or window of a web site which may be linked to the page depicted in FIG. 15.

FIG. 17 depicts a representative page or window of a web site which may be linked to the page depicted in FIG. 15.

FIG. 18 depicts a representative page or window of a web site which may be linked to the page depicted in FIG. 15.

FIG. 19 depicts a representative page or window of a web site which may be linked to the page depicted in FIG. 15.

FIG. 20 depicts a representative page or window of a web site which may be linked to the page depicted in FIG. 15.

### DETAILED DESCRIPTION OF A PREFERRED EMBODIMENT

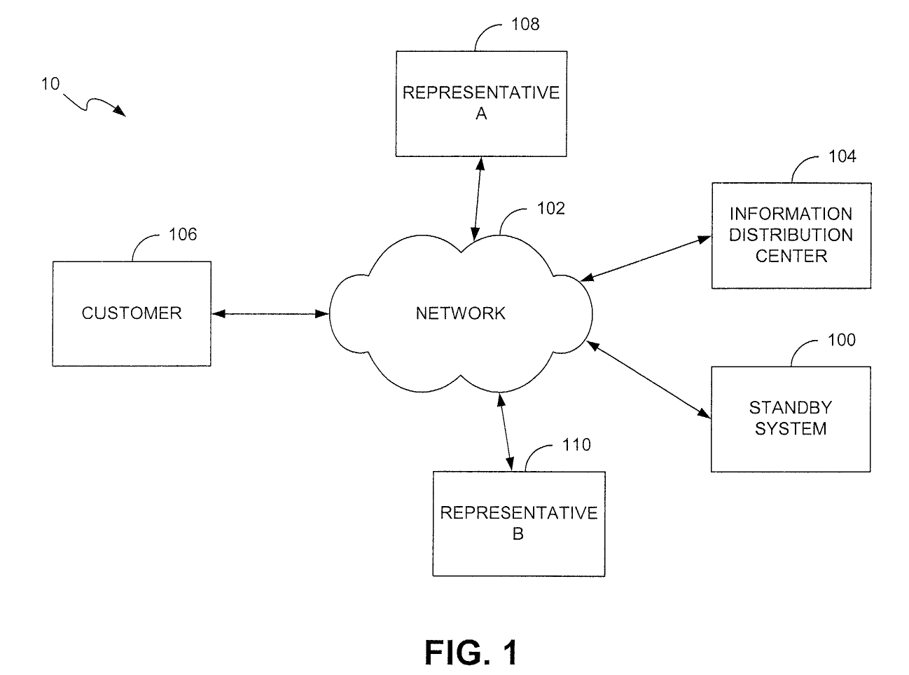

The invention will now be described in detail with reference to the drawings wherein like numerals indicate like parts throughout the several views. As depicted in FIG. 1, a referral system 100 of the present invention includes a standby system 100 that may be configured to communicate with a communications network 102. Communications network 102 may be, for example, the Internet, a local area network (LAN), among others, provided that such a communications network at least partially facilitates intercommunication of various parties, entities, and/or devices. For example, such a network 102 may facilitate intercommunication of the standby system 100 with an information distribution center 104. As utilized herein, the term “information distribution center” is used to describe an entity or component of an entity that is adapted to provide support, such as product and/or service information, for example, to parties, e.g., customers. In order to provide such support, the information distribution center may utilize customer service representative, for example. The term “information distribution center” should not be misinterpreted to denote a geographical limitation, as such a center may actually be a geographically distributed network of representatives.

By way of example, when customer 106 desires information, e.g., information regarding a product and/or service associated or otherwise affiliated with information distribution center 104, the customer may communicate such a desire to information distribution center 104 via network 102, e.g., via telephone, the Internet, etc. As utilized herein, the term “customer” is used to refer to a person(s) who have contacted the information distribution center for the purpose of receiving assistance and/or information. However, such a customer may not have a pre-established business or other relationship/association with the information distribution center and/or any entity associated or otherwise affiliated with the center. As described in detail hereinafter, the information distribution center and, in particular, a customer service representative of the center 104, may interface with the standby system 100 in order to identify an appropriate representative for providing customer 106 with the desired information.

By utilizing standby system 100, a customer service representative may identify representative A (108) as potentially possessing the knowledge required for answering an inquiry received from customer 106. In some embodiments, if representative A currently is unavailable for providing assistance, e.g., representative A is not scheduled to be “on standby,” the standby system 100 may enable the customer service representative to locate another representative, e.g., representative B (110). For instance, representative B may be representative A's duty manager. Thus, standby systems and associated methodologies of the present invention may be utilized for readily and conveniently identifying an appropriate representative(s) for assisting a customer.

Standby systems of the present invention may be implemented in hardware, software, firmware, or a combination thereof. In a preferred embodiment, however, the standby system is implemented as a software package, which can be adaptable to run on different platforms and operating systems and shall be described further herein. More specifically, a preferred embodiment of the stand-by system, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable, programmable, read-only memory (EPROM or Flash memory) (magnetic), an optical fiber (optical), and a portable compact disk read-only memory (CDROM) (optical). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

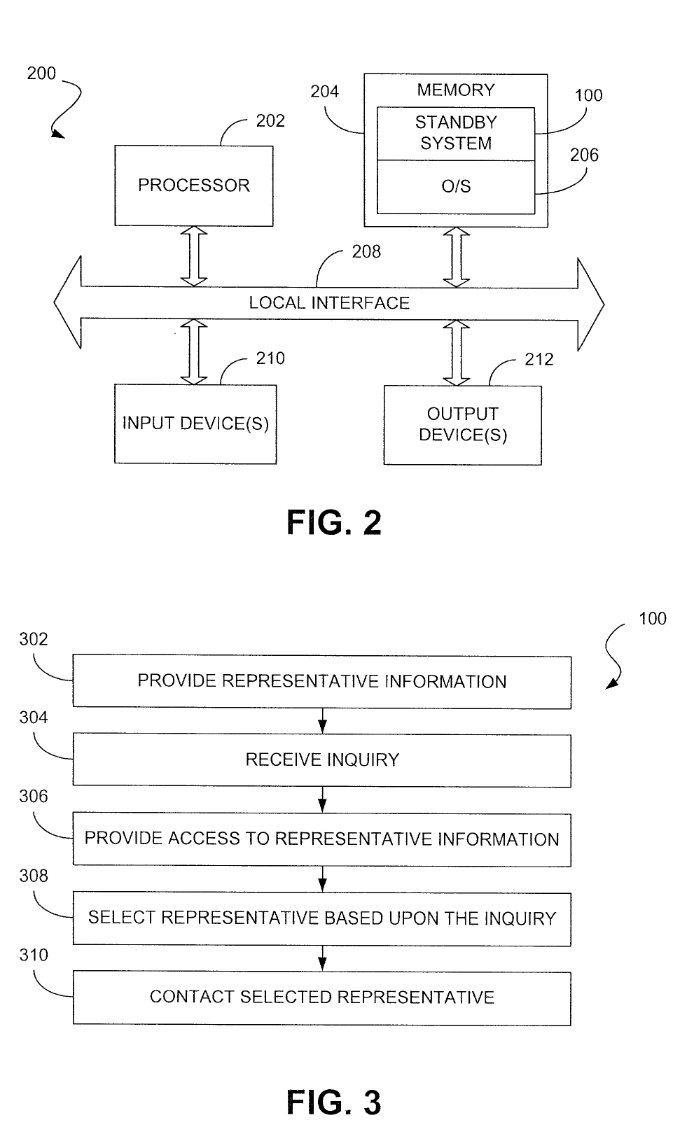

FIG. 2 illustrates a typical computer or processor-based system 200 which may facilitate the standby system 100 of the present invention. As shown in FIG. 2, a computer system 200 generally comprises a processor 202 and a memory 204 with an operating system 206. Herein, the memory 204 may be any combination of volatile and nonvolatile memory elements, such as random access memory or read only memory. The processor 202 accepts instructions and data from memory 204 over a local interface 208, such as a bus(es). The system also includes an input device(s) 210 and an output device(s) 212. Examples of input devices may include, but are not limited to, a serial port, a scanner, a keyboard, a phone connection, or a local access network connection. Examples of output devices may include, but are not limited to, a video display, a Universal Serial Bus, document generator, a printer port, or a local access network connection. Generally, this system may run any of a number of different platforms and operating systems, including, but not limited to, HP-ux™, Linux™, UniX™, Sun Solaris™ or Windows NT™ operating systems. The standby system of the present invention, the functions of which shall be described hereinafter, resides in memory 204 and is executed by the processor 202. It should be noted that one or more processor-based systems, such as the processor-based system depicted in FIG. 2, for example, may be utilized to facilitate the functionality described hereinafter, with the one or more processor-based systems being communicatively coupled, e.g., in a network environment, so that the systems may cooperate to provide the various functions described herein.

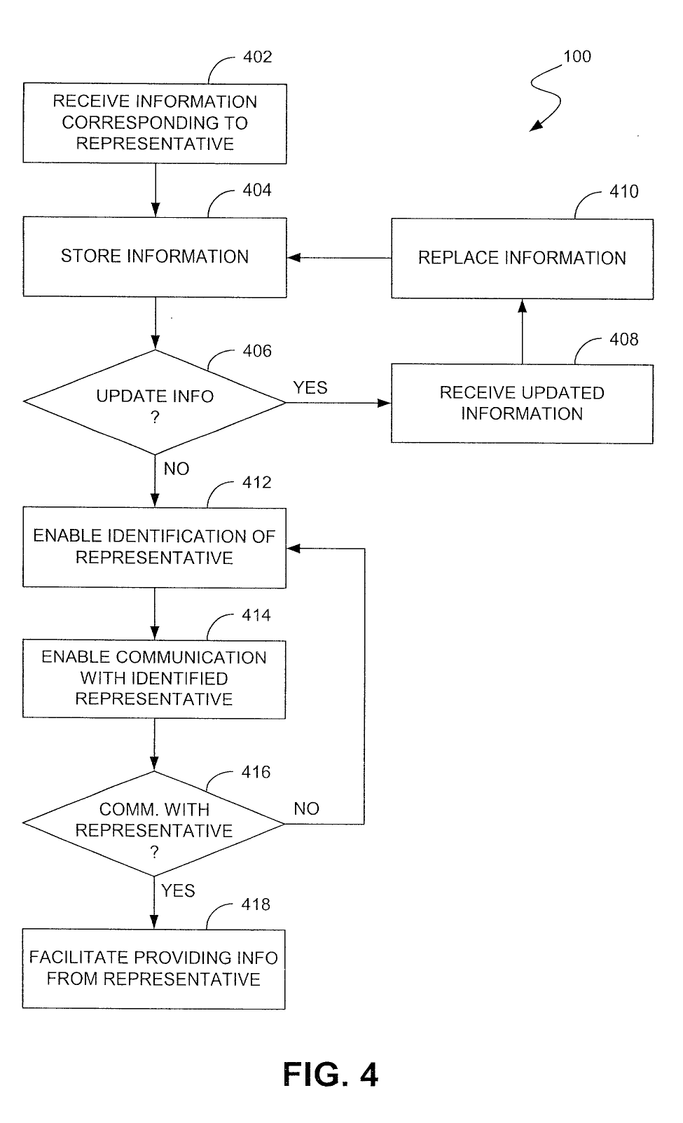

The flowcharts of FIGS. 3 and 4 show the functionality of representative implementations of the standby system. In this regard, each block of the respective flowcharts represents a module segment or portion of code which comprises one or more executable instructions for implementing the specified logical function or functions. It should also be noted that, in some alternative implementations, the functions noted in the various blocks may occur out of the order depicted. For example, two blocks shown in succession in FIG. 3 may, in fact, be executed substantially concurrently where the blocks may sometimes be executed in the reverse order depending upon the functionality involved.

As depicted in FIG. 3, functionality of a preferred standby system or method 100 may be construed as beginning at block 302 where personnel information corresponding to a particular representative, such as an employee, for example, is provided. Thereafter, such as in block 304, an inquiry may be received. For instance, such an inquiry may regard subject matter or information desired by a customer relating to a particular product and/or service, with the inquiry being communicated to a customer service representative of an information distribution center, for example. As depicted in block 306, access may be provided to the representative information and, based upon the personnel or representative information, a particular representative may be selected. Preferably, selection of the representative may be facilitated by correlating the particular inquiry with a support category with which the representative is associated. As utilized herein, the term “support category” generally refers to an area(s) of knowledge or expertise that an employee may possess. In this regard, an employee, such as a technical sale representative, a project engineer, or a department manager, for example, may be associated with one or more support categories which may include products and/or services, for example. In block 310, the selected representative may be contacted so that the representative may provide information to satisfy the inquiry, such as by communicating the information directly to the customer or indirectly via the customer service representative.

Referring now to FIG. 4, functionality of another embodiment of the standby system or method 100 may be construed as beginning at block 402 where information corresponding to a particular representative is received. As depicted in block 404, the received information may be stored, such as in a database, for example. Thereafter, such depicted in block 406, a determination may be made as to whether the stored personnel information is to be updated. If it is determined that the personnel information is to be updated, the process proceeds to block 408 where updated information is received. As shown in block 410, after receiving the updated information, the previously stored information may be replaced by the updated information. If, however, it was determined in block 406 that the personnel information need not be updated or, alternatively, if the information currently does not require updating, the process may proceed to block 412.

As shown in block 412, identification of a particular representative may be enabled. More specifically, access may be provided to at least a portion of the stored personnel information, thereby enabling a representative(s) associated with or corresponding to specific information to be selected. For instance, stored information corresponding to the representative may include a listing of support categories, e.g., products, services, technical expertise, etc., associated with that representative. So provided, a customer service representative attempting to provide a response to a customer inquiry may readily associate or identify a particular representative potentially possessing the subject matter or information required in order to respond to the customer's inquiry. As depicted in block 414, after an appropriate representative has been identified, the standby system preferably facilitates or enables communication with the identified representative. By way of example, the personnel information may include contact information that may be utilized for communicating with the identified representative. In some embodiments, the ability to initiate a phone call, page, or other method or mode of communication to the identified representative by utilizing the contact information may be facilitated.

Proceeding to block 416, a determination then may be made as to whether communication with the identified representative was established. If such communication was not established, the process may return to block 412 where identification of another suitable representative may be facilitated. The process may then proceed as described hereinbefore until communication is established. Thereafter, the process may proceed to block 418 where providing the information from the identified representative to the customer is facilitated. In some embodiments, providing the information may be facilitated by placing the identified representative directly in communication with the customer whereas, in some embodiments, a customer service representative may retrieve the information from the identified representative and then transfer that information to the customer.

It should be noted that the aforementioned standby system or method 100 may be implemented so that multiple simultaneous or nearly simultaneous executions of the aforementioned functions may be accomplished. For instance, when the aforementioned functionality is implemented by utilizing a web site, for example, multiple users may simultaneously, or nearly simultaneously, be entering representative information, identifying representative, and communicating with identified representatives as well as customers.

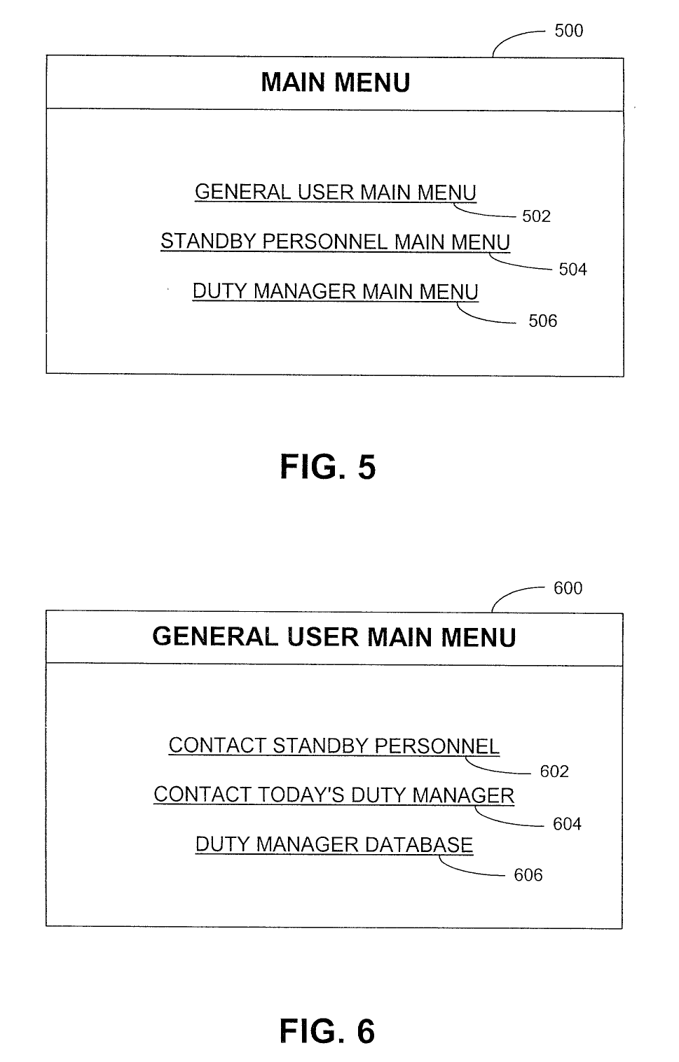

Reference will now be made to FIGS. 5-20 which depict representative pages or windows of a web site that may implement a preferred embodiment of the standby system of the present invention. In this regard, FIG. 5 depicts a representative main menu page 500 which may be displayed to a customer service representative, for example, via a display device. By way of example, such a display device may be a portion of a customer service representative work station at an information distribution center. As depicted in FIG. 5, main menu 500 may provide such a customer service representative or other user to various functions or flows of the standby system. For instance, the main menu may provide access to a general user main menu, a standby personnel main menu, and/or a duty manager main menu. Access to the various functions or flows may be provided in numerous manners with all such manners being considered well within the scope of the present invention. In the embodiment depicted in FIG. 5, however, access to the general user main menu is facilitated by actuating link 502, access to the standby personnel main menu is facilitated by actuating link 504, and access to the duty manager main menu is facilitated by actuating link 506.

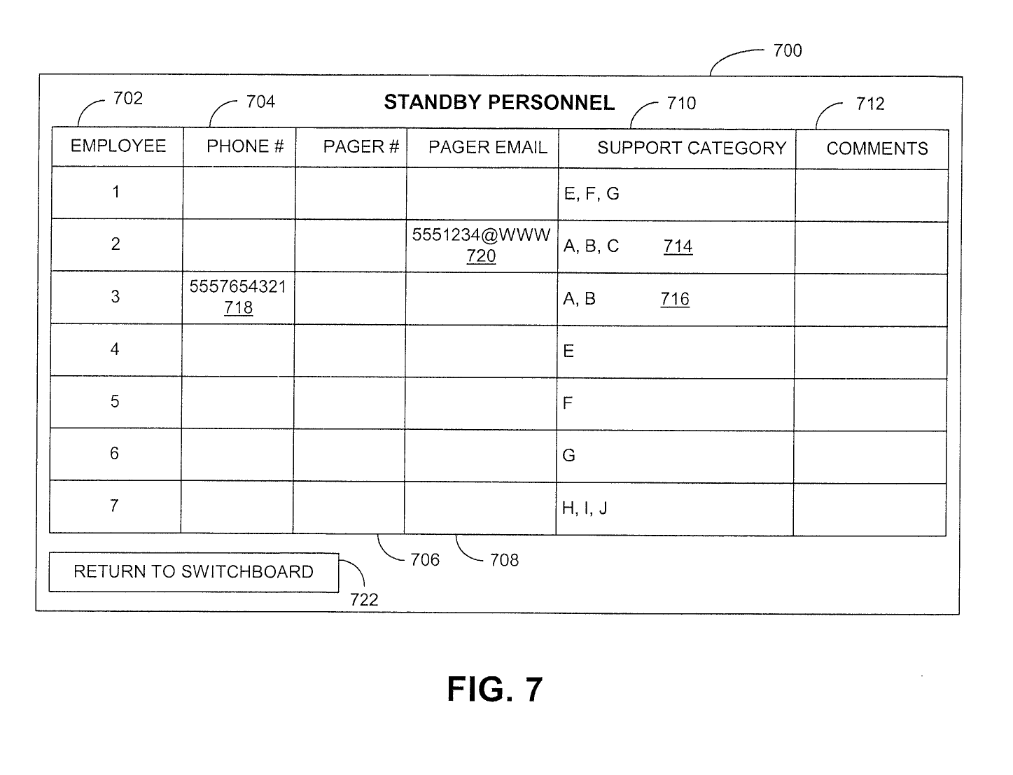

A representative general user main menu 600 is depicted in FIG. 6. The general user main menu preferably includes various links, such as contact standby personnel link 602, contact today's duty manager link 604, and a link to the duty manager database 606. In operation, when an inquiry is received, e.g., received by a customer service representative at the information distribution center, and the representative receiving the inquiry is unable to provide an appropriate response to the customer, the customer service representative may actuate the contact standby personnel link 602. The standby system then may provide the customer service representative with a window or screen 700 (depicted in FIG. 7). Preferably, screen 700 includes information corresponding to various standby representatives or personnel.

For example, in the embodiment depicted in FIG. 7, information may be provided in a column/row format. For the purpose of example, and not limitation, column 702 may contain employee identification information (name), column 704 may include a phone number, column 706 may include a pager number, column 708 may include a pager e-mail address, column 710 may include support category information, and column 712 may include additional comments. Thus, if a customer service representative has determined that a received inquiry corresponds to support category A, the customer service representatives may readily determine that employees 2 and 3 potentially possess the required knowledge to appropriately respond to the inquiry. More specifically, cells 714 and 716 each contain information designating employees 2 and 3 as potentially possessing knowledge associated with support category A. Thereafter, the customer service representative may attempt to contact employee 3, for example, such as by placing a phone call to employee 3 by utilizing the phone number displayed in cell 718. In some embodiments, cell 718 may be configured as a link, whereby actuation of cell 718 by the customer service representative may automatically place a call to employee 3 by utilizing the number displayed in cell 718. After establishing communication with the employee via phone, the customer service representative may obtain the desired information from the employee and/or the employee may be placed in direct contact with the customer.

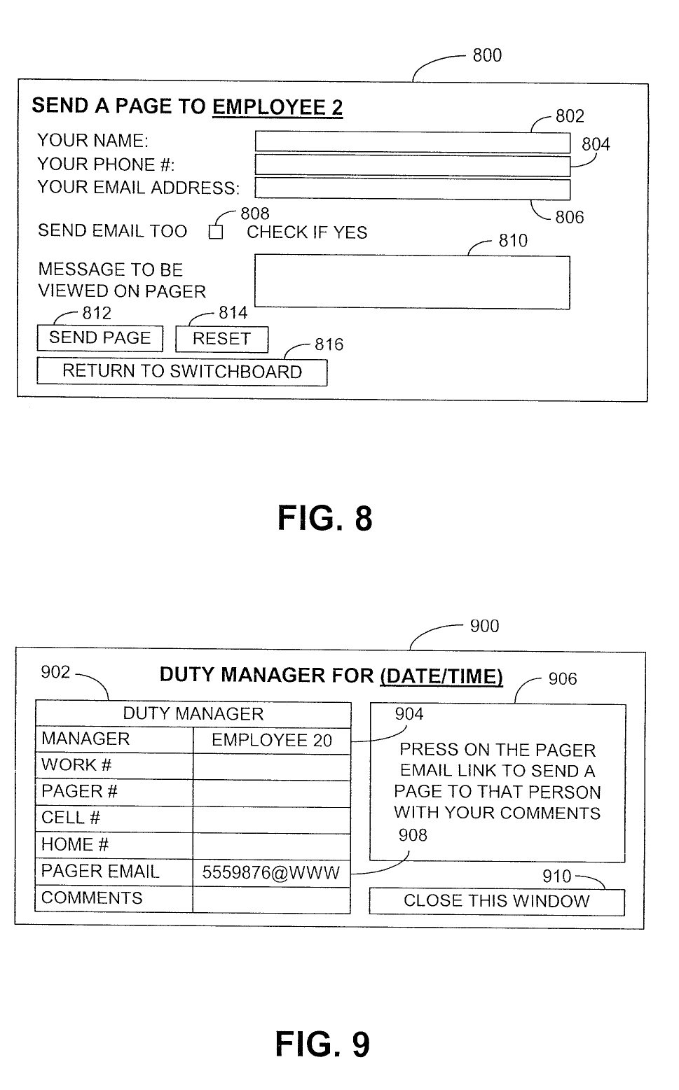

In contrast to contacting one of the employees via phone, the embodiment depicted in FIG. 7 may facilitate contacting an employee via an e-mail pager. For example, the customer service representative may have chosen to contact employee 2, such as by utilizing the pager e-mail address depicted in cell 720. In some embodiments, cell or actuator 720 may serve as a link, whereby upon actuation of link 720 by the customer service representative the standby system may display a screen 800 (FIG. 8) to the customer service representative. Preferably, screen 800 facilitates paging of the corresponding employee (in this case, employee 2). Screen 800 may include fields for entry and display of contact data, such as field 802 (name), field 804 (phone number), and 806 (e-mail address). The aforementioned field 802-806 may be utilized by entering information corresponding to the customer service representative or the particular customer desiring information. If it is desired that an e-mail page be sent, an e-mail page may be designated for sending by actuating box 808, for example. Thereafter, an appropriate message to be viewed may be entered in text box 810. Once appropriate information has been provided in one or more of the various fields of screen 800, the page may be sent to the corresponding employee by actuating icon 812. If, however, information appearing in one or more of the various fields requires alteration, reset icon 814 may be actuated and appropriate information may be re-entered. When the customer service representative desires returning to screen 700 (FIG. 7), the “return to switchboard” icon 816 may be actuated.

Referring back to the general user main menu 600 of FIG. 6, it may be desirable for a customer service representative to contact a duty manager. For instance, when an inquiry has been received and the appropriately designated standby personnel are not able to be contacted, a customer service representative may actuate link 604 for the purpose of contacting an appropriate duty manager. Once so actuated, the customer service representative preferably is provided with a display 900 (FIG. 9). Screen 900 may include a representation of the date/time of duty for the corresponding duty manager as well as a contact information area 902. Preferably, area 902 includes information which may include, but is not limited to manager's name, work phone number, pager number, cell phone number, home phone number, pager e-mail, and/or comments. For example, in the representative example depicted in FIG. 9, the duty manager is employee 20 (shown in cell 904). An instruction area 906 also may be provided within screen 900. For example, area 906 may inform the user that a pager e-mail may be sent to the duty manager by actuating a pager e-mail link. Such a link may be configured within the information area 902 and, in this case, is provided as cell (link) 908. Thus, by actuating link 908, the customer service representative may be provided with a screen that is configured to obtain information required to send an appropriate email page to the duty manager. In this regard, the customer service representative may be provided with a screen 800 (FIG. 8), for example. As desired, screen 900 may be closed by actuating icon 910.

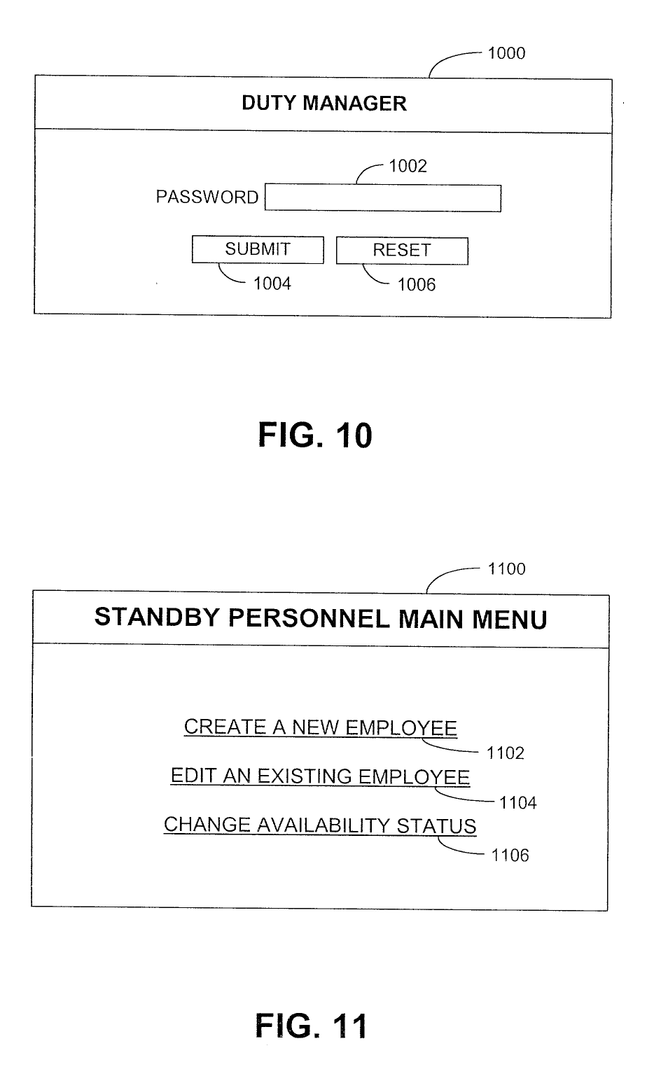

Referring once again to the general user main menu 600 depicted in FIG. 6, a customer service representative also may wish to actuate the duty manager database link 606. Upon actuation of link 606, the customer service representative preferably is provided with a window 1000, such as depicted in FIG. 10. In the embodiment depicted in FIG. 10, access to the duty manager database may be restricted by requiring entry of a pre-established password, such as in field 1002. Upon providing an appropriate password within field 1002, the password may be submitted to the standby system by actuating the submit icon 1004. If, however, the data entered in field 1002 needs to be changed, the reset icon 1006 may be actuated. Upon submission of the password to the standby system and an affirmation by the system that the password is correct, the customer service representative may be provided access to at least a portion of the information contained in the duty manager database.

Reference will now be made once again to the main menu 500, depicted in FIG. 5. As depicted therein, standby personnel main menu link 504 may be actuated, upon which a standby personnel main menu screen 1100 may be displayed (FIG. 11). As shown therein, menu 1100 may provide various links, such as a “create a new employee” link 1102, and “edit an existing employee” link 1104, and a “change of availability status” link 1106. By way of example, the standby system of the present invention may facilitate compilation of employee information by allowing an employee to enter information to be utilized by the standby system. In particular, an employee may be provided with access to the standby system via a computer or processor-based device, such as a workstation, which is configured to intercommunicate with the standby system. Once communication with the standby system is established, the standby system may enable the employee to enter employee related information, such as after actuating the “create a new employee” link 1102 (FIG. 11).

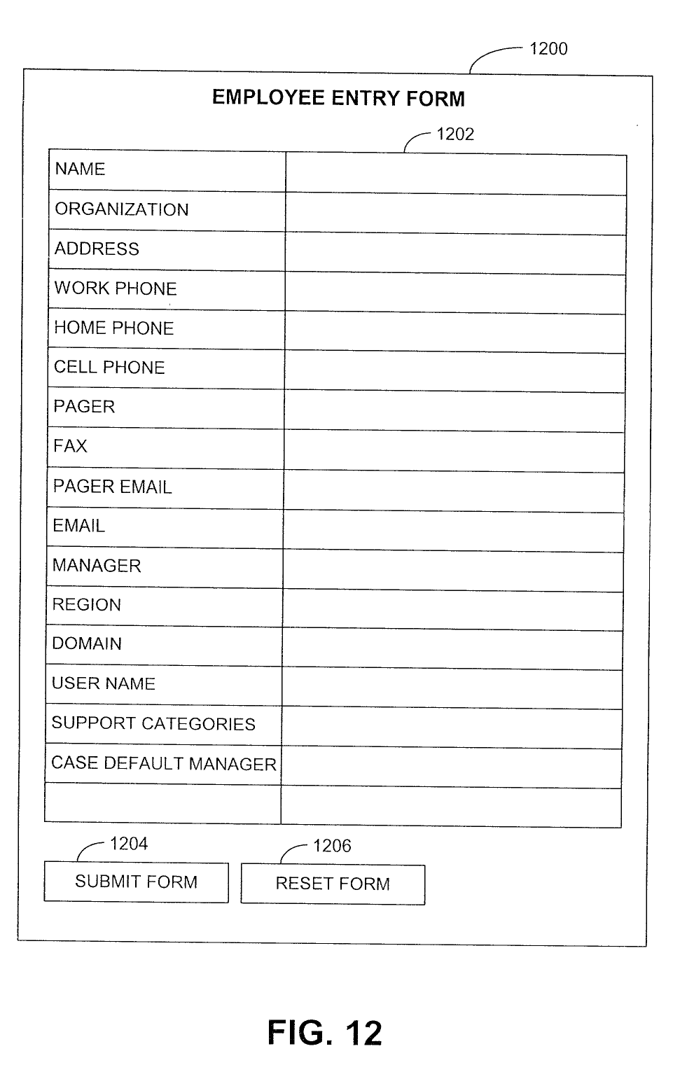

Upon actuating link 1102, the employee may be provided with an employee entry form or screen 1200 (FIG. 12). The embodiment of the employee entry form 1200 depicted in FIG. 12 incorporates an employee information area 1202, which is configured to facilitate entry of various employee data, such as name, organization, address, etc. The information provided via the employee entry form is then compiled by the standby system, e.g., the standby system receives the employee information when the submit form icon 1204 is actuated and the system stores the information. The employee information from the various fields of the information area 1202 may then be available for use by the standby system as required. During entry of data into the employee entry form, reset form icon 1206 may be actuated to facilitate correction of information entry errors.

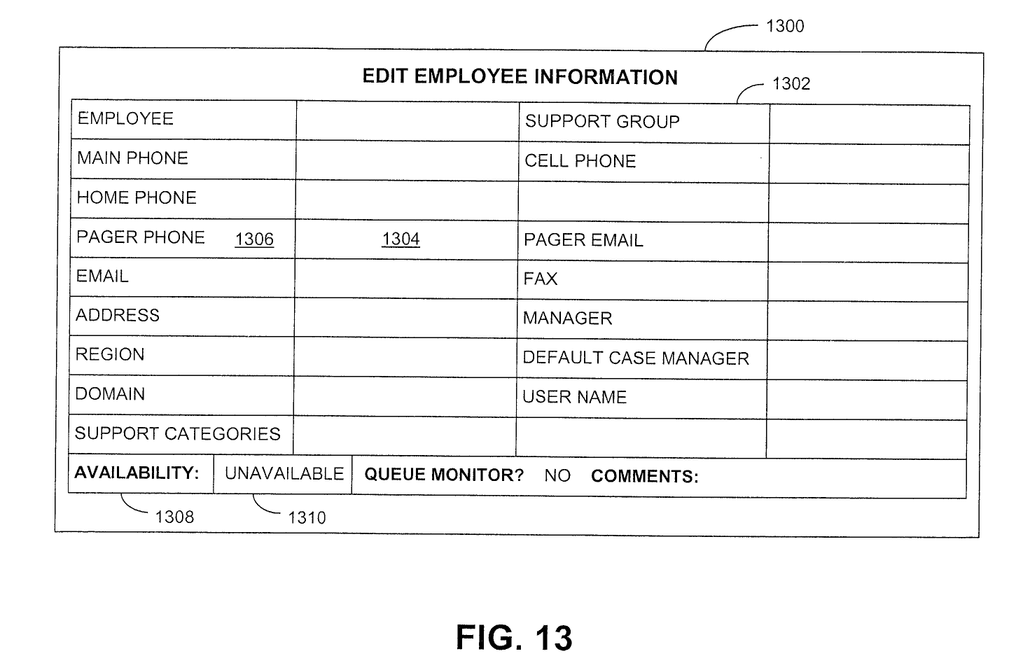

Information provided to the system via the form may be updated by actuating the “edit an existing employee” icon 1104 (FIG. 11). Upon actuation, the employee is presented with an edit employee information form or screen 1300 (FIG. 13). As depicted in FIG. 13, a preferred embodiment of the edit employee information form 1300 includes an information field 1302, which contains information corresponding to the employee that is currently stored by the standby system. If the employee desires to change information displayed within one or more of the cells of area 1302, the edit employee information screen facilitates such a change. For instance, if the employee desires to change the pager number displayed in cell 1304, for example, the employee may actuate cell (icon) 1306, thereby enabling the employee to update the information contained in cell 1304. An employee also may add/change his availability by actuating availability link 1308, with the current availability status being displayed in cell 1310.

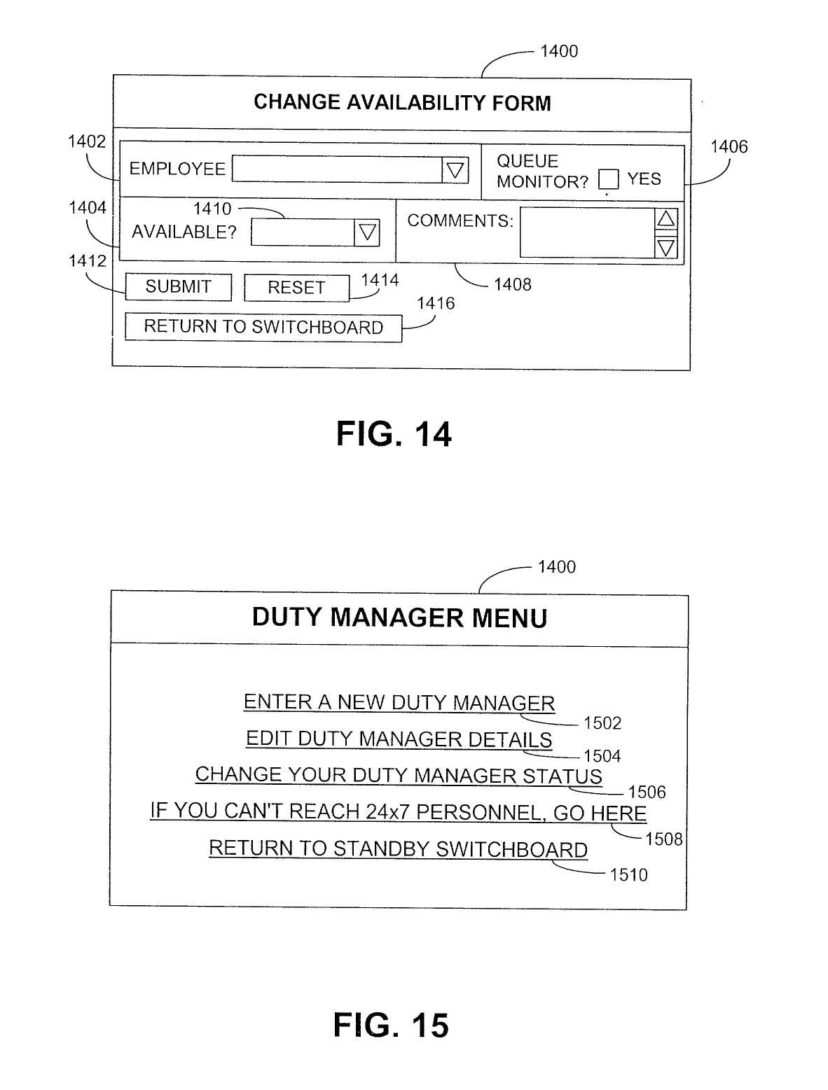

In some embodiments, actuation of the availability link 1308 prompts the standby system to display a change availability form or screen 1400 to the employee (FIG. 14). Such a change availability form may include various fields including employee field 1402, availability field 1404, queue monitor field 1406, and comments field 1408. For example, employee field 1402 may provide a display corresponding to the employee about whom the current availability is to be changed. In regard to the availability field 1404, this field may enable the employee to designate a particular time period or periods within which he is to be available. A drop down menu 1410 may be provided, in some embodiments, in order to facilitate this functionality.

Once the appropriate information has been provided via one or more of the various fields, the information may be submitted to the standby system by actuating the submit icon 1412. If, however, changes to the information presented via form 1400 are desired, the employee may actuate the reset icon 1414. A return to switchboard icon 1416 also is provided, which returns the employee to a display, such as depicted in FIG. 11.

As depicted in FIG. 11, access to the change availability form 1400 also may be achieved by depressing the change availability status icon 1106 of menu 1100.

Referring once again to the main menu 500 depicted in FIG. 5, a user may be provided with a duty manager menu upon actuating the duty manager main menu icon 506. Such a duty manager menu 1500 is depicted in FIG. 15. As shown therein, a preferred duty manager menu provides various icons including, for example, an “enter a duty manager” link 1502, an “edit duty manager details” link 1504, a “change your duty manager status” link 1506, an “if you can't reach 24×7 personnel” link 1508, and a “return to standby switchboard” link 1512.

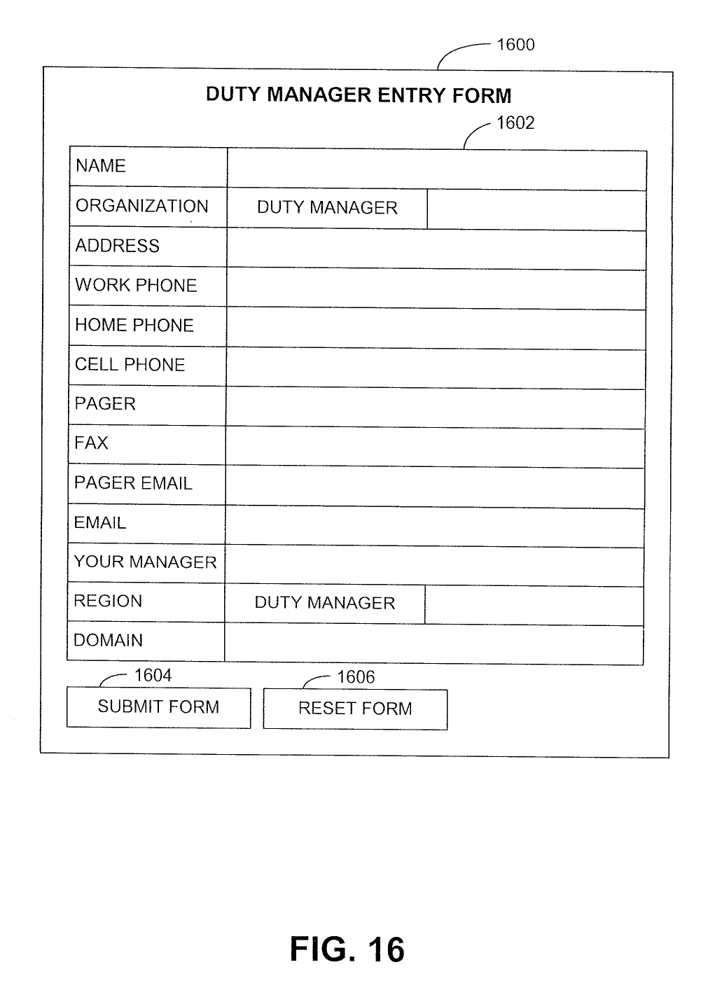

Not unlike the create a new employee link 1102 and it's associated employee entry form 1200 (FIG. 12), the enter a new duty manager link 1504 preferably provides a user with access to a duty manager entry form 1600 (FIG. 16). Preferably, the duty manager entry form 1600 includes an information area 1602, which may include one or more field into which duty manager information may be provided. Upon appropriate entry of such information, the duty manager information may be submitted to the standby system for compilation by actuating the submit form icon 1604. A reset form icon 1606 also is provided.

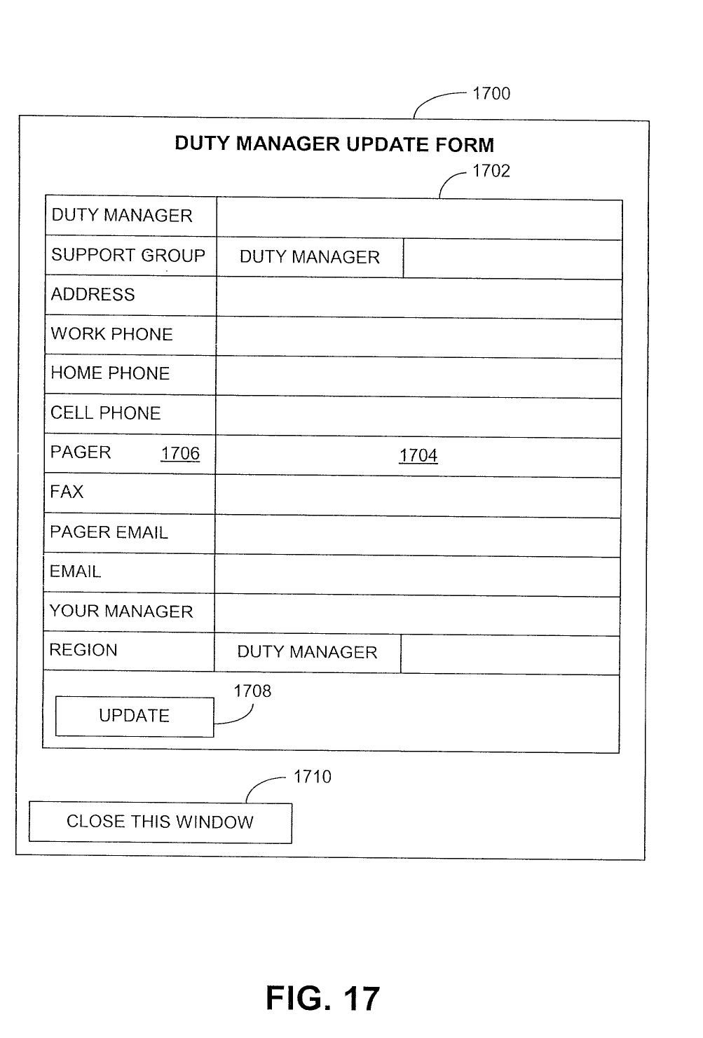

Similarly, a duty manager update form also is provided that is accessible via the actuation of the “edit duty manager details” link 1506 (FIG. 15). A representative example of a duty manager update form 1700 is depicted in FIG. 17. The duty manager update form includes an information area 1702, which is configured to display the duty manager information currently stored by the standby system. Additionally, the duty manager update form is configured to enable the user, e.g., the duty manager, to edit information provided and currently stored by the standby system. For instance, if the duty manager desires updating the information provided in cell 1704, e.g., pager number, the user may actuate cell (link) 1706 which will enable the user to then modify the information presented in cell 1704. After any appropriate modifications have been made to the information display via the duty manager update form 1700, the updated information may be provided to the standby system by actuating the update icon 1708. The duty manager form then may be closed by actuating icon 1710.

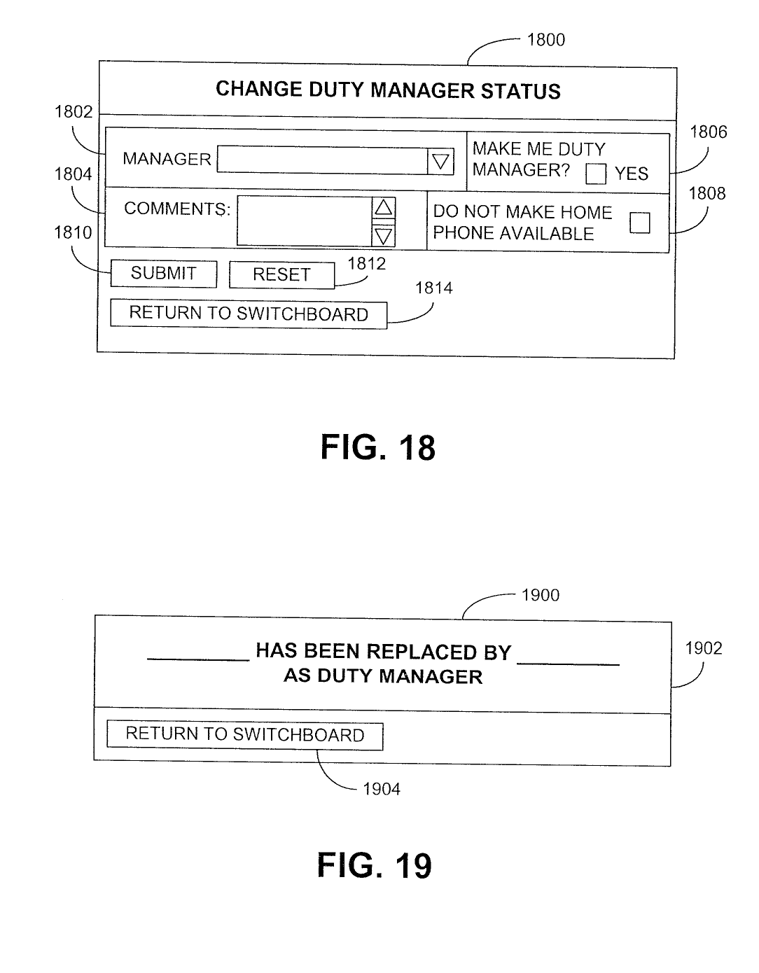

Referring once again to the duty manager menu 1500 of FIG. 15, actuation of the “change your duty manager status” link 1502 preferably prompts the standby system to provide the user with a change duty manager status screen 1800 (FIG. 18). Preferably, the change duty manager status screen or window 1800 includes various information fields including, manager identification field 1802, comments field 1804, duty manager activation field 1806, and a home phone availability field 1808. Preferably, the duty manager's name is provided in field 1802, comments may be provided by the duty manager in field 1804, and decisions such as whether to activate the identified manager as the duty manager, and whether or not to make the duty manager's home phone number available for use may be facilitated by fields 1806 and 1808, respectively. Additionally, a submit icon 1810, a reset icon 1812, and a “return to switchboard” icon 1814 may be provided.

In some embodiments, in order to ensure that the standby system has recognized that a new duty manager has become available, upon submitting information corresponding to the activation of a new duty manager to the system, such as via the change duty manager status window 1800, the user may be provided with a window 1900 (FIG. 19), for example. For instance, window 1900 may provide an information field 1902 that expressly recites that the previous duty manager has been replaced by the new duty manager. A “return to switchboard” icon 1904 also may be provided that enables a return to the duty manager menu 1500 (FIG. 15), for example.

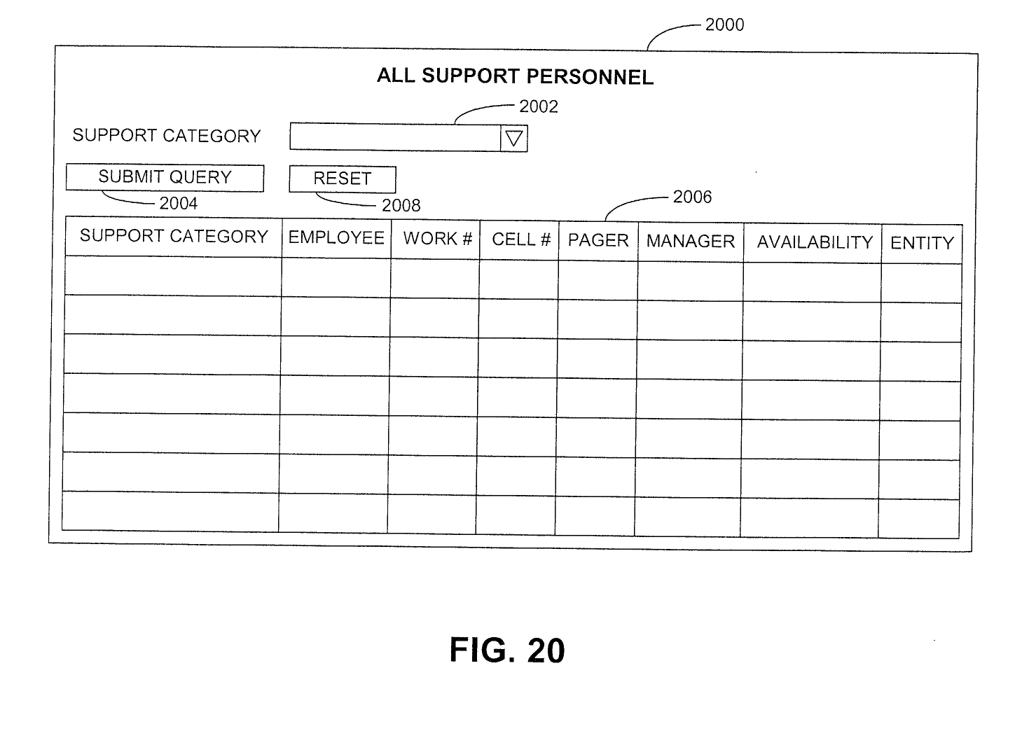

As depicted in FIG. 15, a user also may desire to actuate link 1508, which may be actuated when the designated standby personnel can't be reached. Upon actuation of link 1508, a support personnel window 2000 preferably is displayed to the user (FIG. 20). Preferably, such a support personnel window includes a support category field 2002, which may be facilitated by a drop down menu, for example. Upon selection of an appropriate support category via field 2002 and submission of the selected support category by actuating the submit query icon 2004, employee information corresponding to employees with expertise in the selected support category may be displayed in the employee information area 2004. Thus, much like the standby personnel window 700 depicted in FIG. 7, various contact links may be provided for contacting personnel that potentially possess information for responding to an inquiry, as described hereinbefore.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

1. A method for providing a customer with information comprising the steps of:
enabling receipt of personnel information corresponding to a first representative, the personnel information including support category information and contact information, the support category information pertaining a first subject matter about which the first representative possesses knowledge, the contact information pertaining to at least one method of communicating with the first representative;
enabling the first representative to be identified in response to a customer inquiry regarding the first subject matter;
enabling communication with the first representative by utilizing the contact information; and
enabling the customer to be provided with information pertaining to the first subject matter.

2. The method of claim 1, wherein the step of enabling the first representative to be identified comprises the step of:
enabling access to be provided to at least a portion of the personnel information.

3. The method of claim 1, wherein the step of enabling receipt of personnel information comprises the steps of:
enabling the first representative to provide corresponding personnel information;
enabling the personnel information corresponding to the first representative to be stored;
enabling the personnel information corresponding to the first representative to be updated so that update personnel information is stored.

4. The method of claim 1, wherein the step of enabling the customer to be provided with information comprises the step of:
enabling the first representative to communicate directly with the customer.

5. The method of claim 1, further comprising the step of:
enabling receipt of personnel information corresponding to a second representative, the personnel information including support category information and contact information, the support category information pertaining a first subject matter about which the second representative possesses knowledge, the contact information pertaining to at least one method of communicating with the second representative such that, if the first representative is unable to provide information pertaining to the first subject matter:
the second representative may be identified in response to the customer inquiry regarding the first subject matter; and
communication with the second representative may be established by utilizing the contact information, thereby enabling the second representative to provide information pertaining to the first subject matter.

6. The method of claim 2, wherein the step of enabling communication with the first representative comprises the steps of:
enabling selection of a first method of communicating with the first representative; and
enabling communication with the first representative by utilizing the first method.

7. A referral system for providing a customer with information comprising:
a standby system configured to:
receive personnel information corresponding to a first representative, the personnel information including support category information and contact information, the support category information pertaining a first subject matter about which the first representative possesses knowledge, the contact information pertaining to at least one method of communicating with the first representative;
store the personnel information;
enable identification of the first representative in response to a customer inquiry regarding the first subject matter; and
enable communication with the first representative by utilizing the contact information such that the customer may be provided with information pertaining to the first subject matter.

8. The referral system of claim 7, further comprising:
an information distribution center communicating with said standby system, said information distribution center being configured to receive the customer inquiry.

9. The referral system of claim 8, wherein said standby system is implemented via a Web site, and wherein communication between said information distribution center and said standby system is facilitated via the Internet.

10. The referral system of claim 8, wherein said standby system is implemented via a graphical user interface, and wherein communication between said information distribution center and said standby system is facilitated via a communication network.

11. The referral system of claim 9, wherein said Web site is configured to provide an actuator corresponding to the first representative, said actuator being configured to enable communication with the first representative such that, in response to actuating the actuator, said Web site facilitates sending an email page to the first representative.

12. The referral system of claim 10, wherein said standby system is configured to provide said information distribution center with access to at least a portion of the personnel information.

13. The referral system of claim 10, wherein said standby system comprises
means for providing said information distribution center with access to at least a portion of the personnel information.

14. The referral system of claim 10, wherein said standby system is configured to:
enable the first representative to provide corresponding personnel information;
store the personnel information corresponding to the first representative; and
enable the personnel information corresponding to the first representative to be updated such that update personnel information is stored.

15. The referral system of claim 10, wherein said standby system comprises:
means for enabling the first representative to provide corresponding personnel information;
means for storing the personnel information corresponding to the first representative; and
means for enabling the personnel information corresponding to the first representative to be updated such that update personnel information is stored.

16. The referral system of claim 10, wherein said standby system is configured to:
enable selection of a first method of communicating with the first representative; and
enable communication with the first representative by utilizing the first method.

17. The referral system of claim 10, wherein said standby system comprises:
means for enabling selection of a first method of communicating with the first representative; and
means for enabling communication with the first representative by utilizing the first method.

18. The referral system of claim 10, further comprising:
a work station communicating with said standby system, said work station being configured to enable the first representative to provide corresponding personnel information to said standby system.

19. A computer readable medium having a computer program for providing a customer with information comprising:
logic configured to enable receipt of personnel information corresponding to a first representative, the personnel information including support category information and contact information, the support category information pertaining a first subject matter about which the first representative possesses knowledge, the contact information pertaining to at least one method of communicating with the first representative;
logic configured to enable the first representative to be identified in response to a customer inquiry regarding the first subject matter; and
logic configured to enable communication with the first representative by utilizing the contact information such that the customer may be provided with information pertaining to the first subject matter.

20. The computer readable medium of claim 19, wherein said logic configured to enable the first representative to be identified comprises logic configured to enable access to be provided to at least a portion of the personnel information.

21. The computer readable medium of claim 19, wherein said logic configured to enable receipt of personnel information comprises:
logic configured to enable the first representative to provide corresponding personnel information;
logic configured to enable the personnel information corresponding to the first representative to be stored; and
logic configured to enable the personnel information corresponding to the first representative to be updated so that update personnel information is stored.

22. The computer readable medium of claim 19, wherein said logic configured to enable communication with the first representative comprises:
logic configured to enable selection of a first method of communicating with the first representative; and
logic configured to enable communication with the first representative by utilizing the first method.
